(19) United States
(12) Patent Application Publication
(10) Pub. No.: US 2006/0005640 A1
(43) Pub. Date: Jan. 12, 2006

(54) Analyzer system

(75) Inventor: Naoki Osaka, Kyoto-fu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shimadzu Corporation, Kyoto (JP)

(21) Appl. No.: 11/176,185

(22) Filed: Jul. 8, 2005

(30) Foreign Application Priority Data
Jul. 9, 2004 (JP) 2004-202944

(51) Int. Cl. G01N 1/14

(52) U.S. Cl. 73/863.83

(57) ABSTRACT

An analyzer according to the present invention works as a server when it is connected via the network to a personal computer (PC) on which a commonly-used browser is installed. The analyzer includes: a) a still image generating section for generating data of a still image at every first predetermined time interval, and storing the data in a data storing section; b) a program storing section for storing a program which reads out data of a latest still image from the analyzer at every second predetermined time interval; and c) a program sending section for sending the program to the personal computer when a predetermined URL of the analyzer is accessed by the browser of the personal computer. When a user of the analyzer starts a browser on the PC, and designates a predetermined URL of the sever, i.e., the analyzer, the browser establishes a connection with the server of the URL. When the connection is completed, the server, or analyzer, sends a set of data identified by the URL to the browser of the PC that requested it. In the set of data sent to the PC, the above-described program is included. On receiving the program, the browser executes the program, which sends a request to the analyzer to send the data of the latest still image to the client (PC). Responsive to the request, the analyzer reads out the data of the latest still image, and sends it to the client. The client PC shows the still image of the data in a predetermined area of the browser shown on the display screen. This lets the user of the analyzer who is watching the display screen to know the current status of the analysis.

The present invention relates to an analyzer system including an analyzer, such as a liquid/gas chromatograph or a mass spectrometer, and a computer, such as a personal computer, connected to the analyzer via a network.

### BACKGROUND OF THE INVENTION

Many recent analyzers are equipped with a personal computer (PC) which is connected to the main unit of the analyzers via a signal line. The main unit of the analyzer itself is equipped with a microprocessor (or microprocessors) for controlling every part of the analyzer in every process step, while the PC is used as the interface between the analyzer, or precisely the controller microprocessor of the analyzer, and the operator or user of the analyzer. Using the PC, the operator can set various analyzing conditions, input or choose desired values of various parameters, make a high-level analysis of the data obtained by the analyzer, and show the analysis results or the crude data on a screen of a display. In order to conduct such control over the analyzer and various data analyses of the sampled data, various programs proper to the analyzer are installed in the PC.

For example, in the case of a liquid chromatograph equipped with an auto-sampler, the status of various parts of the auto-sampler, such as the kind of currently-set sample rack, whether a vial is set on the sample rack or not, the type of the flow-cell, the leak of the solvent, the status of the lamp cover, or the status of the door of the column oven, are automatically sensed by respective sensors under the control of appropriate programs. When a sample analysis is started, the stability of the baseline is examined, and various conditions of the system are checked automatically. At a predetermined timing of the analysis, an auto-validation is performed in order to assure the reliability of the analysis result. Details of these controls are described on the website of http://www.an.shimadzu.co. jp/products/1c/1c2010/c2010-3.htm or http://www1.shimadzu.com/products/lab/chromato/1c2010.html (Shimadzu Corporation).

When analyzers were first equipped with a PC, a purpose-built line was used as the signal line between them. Then, as the number of analyzers used in a facility increased, and as the performance of PCs was enhanced, it became common for a PC to control plural analyzers, rather than one to one, and for the PC to perform the data analyses and to display the analyzed data of the plural analyzers. In this case, the connection between the PC and the plural analyzers are made with the normal network generally used between a PC and its peripheral devices, or between plural PCs. Further, as the size of the network grows, the commonly-used network protocol, i.e., the TCP/IP, is used for the PC-analyzer network. In this case, as described in Unexamined Japanese Patent Publication No. 2004-85356, the PC uses, for the network communication with the analyzers, commonly-used browsers, such as Internet Explorer (Microsoft Corporation) or Netscape Navigator (Netscape Communications Corporation).

When a proper program (analyzer program) for controlling an analyzer, for analyzing data or for showing the results is installed in a PC, the analyzer program itself, or other programs also installed in the PC before or after it, may become unstable, probably due to an incompatibility between the analyzer program and other normal programs, or between the analyzer program and the PC.

When a commonly-used browser is used, instability due to such an incompatibility is alleviated. However, since commonly-used browsers are not programs made for controlling analyzers or analyzing data, they are not suitable for minutely controlling analyzers or analyzing/showing the data. For example, when an object URL is accessed and shown on the screen of a PC display, the server, which is an analyzer in the present case, of the URL sends the then-current data to the client, which is the PC in the present case. This means that the commonly-used browser is suitable for receiving data of a text or a still picture, but is not suitable for receiving and showing data of a moving picture or a changing picture. In many cases, commonly-used browsers can accommodate so-called plug-in programs, and by using an appropriate plug-in program, a moving picture or a changing picture can be shown on the screen. In this case, however, the user should obtain and install such a plug-in program in association with the browser, and, on the server side, an appropriate high-level, high-performance program corresponding to the plug-in program is also necessary.

### SUMMARY OF THE INVENTION

In view of the above-described problems, an object of the present invention is to provide an analyzer system that, while allowing the use of a conventional simple PC system, enables the observation of an analyzer or analyzers as frequently as possible, and also enables collecting data from the analyzer or analyzers as frequently as possible.

According to the present invention, an analyzer having a function of a server that is connected to a personal computer (PC) on which a browser is installed via a network, includes:
a) a still image generating section for generating data of a still image at every first predetermined time interval, and storing the data in a data storing section;
b) a program storing section for storing a program which reads out data of a latest still image from the analyzer at every second predetermined time interval; and
c) a program sending section for sending the program to the personal computer when a predetermined URL of the analyzer is accessed by the browser of the personal computer.

The analyzer of the present invention has a server function, that is, when it is connected to the PC with a browser via a network, it sends data in response to a request externally given through the network. In the present invention, such a request is done by the browser of the PC.

In the analyzer, while an analysis is performed, at least a part of the information of the analysis to be sent out of the analyzer is made into data of a still image. For example, in the case of a liquid chromatograph, a series of chromatograms are built using the signal from the detector and time data from a timer, where the chromatograms gradually change. The newest chromatogram is made into data of a still image, and the data is stored in the data storing section by the still image generating section. After the first predetermined time interval (five seconds, for example), the newest chromatogram is again made into data of a still image, and the data is stored in the data storing section. These are repeated at every first predetermined time interval, whereby it is assured that the newest data of still image is always stored in the data storing section of the analyzer.

The analyzer has a program storing section in which a program or programs for reading out data of the latest still image from the analyzer at the second predetermined time interval. As described later, the program is sent to the PC when a predetermined URL provided within the analyzer is accessed by the browser of the PC, and is used in the PC. Thus the program or programs must be made to be usable in the browser of the PC. An html or a JavaScript (Sun Microsystems Incorporated) can be used to make such programs. The program is sent by the program sending section.

When a user of the analyzer starts a browser on the PC, and designates the predetermined URL (usually with clicking an appropriate shortcut icon on the display screen rather than inputting the URL letter sequence), the browser establishes a connection with the server of the URL. When the connection is completed, the server (analyzer in the present case) sends a set of data identified by the URL to the browser of the PC that requested it. In the present invention, the set of data sent to the PC when the URL is first accessed includes the above-described program.

On receiving the program, the browser executes the program. Some browsers allow the user to choose whether an externally-sent program is instantaneously executed or not. In this case, the instantaneously executing function should be enabled beforehand. When the program is executed, the program sends a request to the currently connected server (analyzer) to send the data of the latest still image to the client (PC in the present case). Responsive to the request, the server (analyzer) reads out the data of the latest still image, and sends it to the client. When the client PC receives the data, it shows the still image of the data in a predetermined area of the browser shown on the display screen. This lets the user of the analyzer who is watching the display screen know the current status of the analysis.

After the second predetermined time interval since sending the first request described above, the program again sends the request for sending the data of the latest still image. The second predetermined time interval may be or may not be the same as the first predetermined time interval. When the two predetermined time intervals are not the same, the latest still image at the second request may be the same as that at the first request. In this case, the client PC may request the server to send the data of the same still image as before, or the client PC uses the data stored in the cache (or a temporary file) of itself to show the latest still image.

In the network of the present invention, two or more such analyzers or PCs can be connected.

In general, the size of data of an image, even if it is a still image, is large. So the data storing section may overflow if the data of many still images are stored. Thus it is preferable for the still image generating section to delete data that is older than a predetermined period, or to overwrite data of the latest still image onto the older data to always save the space of the data storing section.

According to the present invention, rather slowly changing information of an analysis, such as the pressure of the eluent pump, the column temperature or the chromatogram in the case of a chromatograph, can be shown on the display screen of the PC with an updating speed that can adequately follow the changing speed of the information. In the present invention, such a function can be realized without using high-level plug-ins for moving or changing pictures but by using only the still image showing function that is built-in in commonly-used browsers. Thus it is sufficient for the system of the present invention to properly work by simply installing a commonly-used browser on the PC. A necessary program is provided from the server, or the analyzer. On the server side, also, high-level programs or high-performance CPU or hardware for treating a moving picture is unnecessary. These make the whole analyzer system of the present invention rather low-cost.

### BRIEF DESCRIPTION OF THE DRAWINGS

FIG. 1 is a schematic block diagram of the analyzer system including an LC analyzer embodying the present invention.

FIG. 2 is a detail block diagram of a controller of an LC analyzer and its relating devices.

FIG. 3 is a flowchart of the process done by the image file generating section of an LC analyzer.

FIG. 4 is a flowchart of the process done by the program executed on the browser of a PC.

### DETAILED DESCRIPTION OF A PREFERRED EMBODIMENT

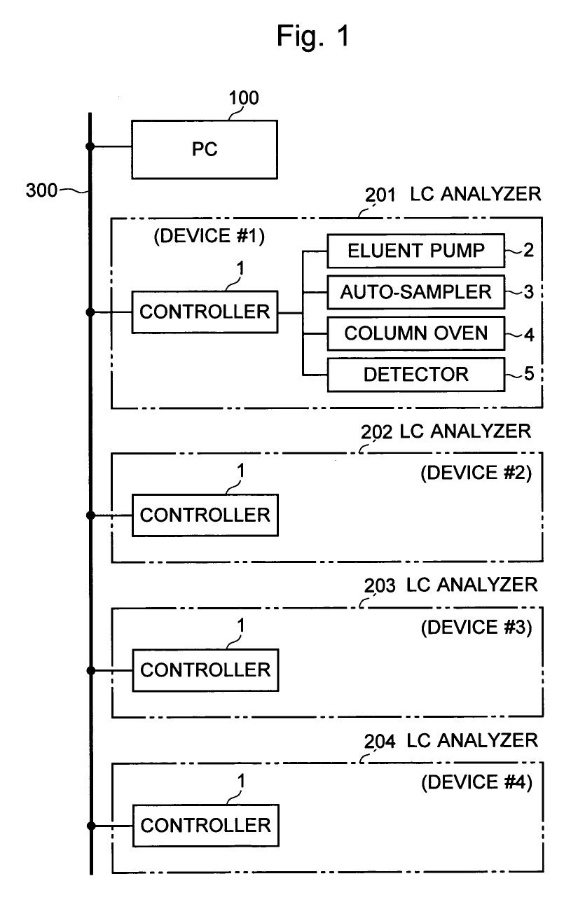

A liquid chromatograph (LC) analyzing system embodying the present invention is described referring to FIG. 1. In the LC analyzing system, four LC analyzers 201-204 and a personal computer (PC) 100 are connected to a network 300 such as an intranet. The four LC analyzers 201-204 have the same construction, so that one of them is detailed in FIG. 1.

The LC analyzer 201 includes, as analyzing parts, an eluent pump 2, a column oven 4 in which a separation column is provided, an auto-sampler 3 for injecting a shot of sample in the eluent flowing to the column, and a detector 5 for detecting components of the sample separately flowing out of the column. The LC analyzer 201 further includes a controller unit 1 which controls the analyzing parts according to predetermined conditions, and collects data from the detector 5.

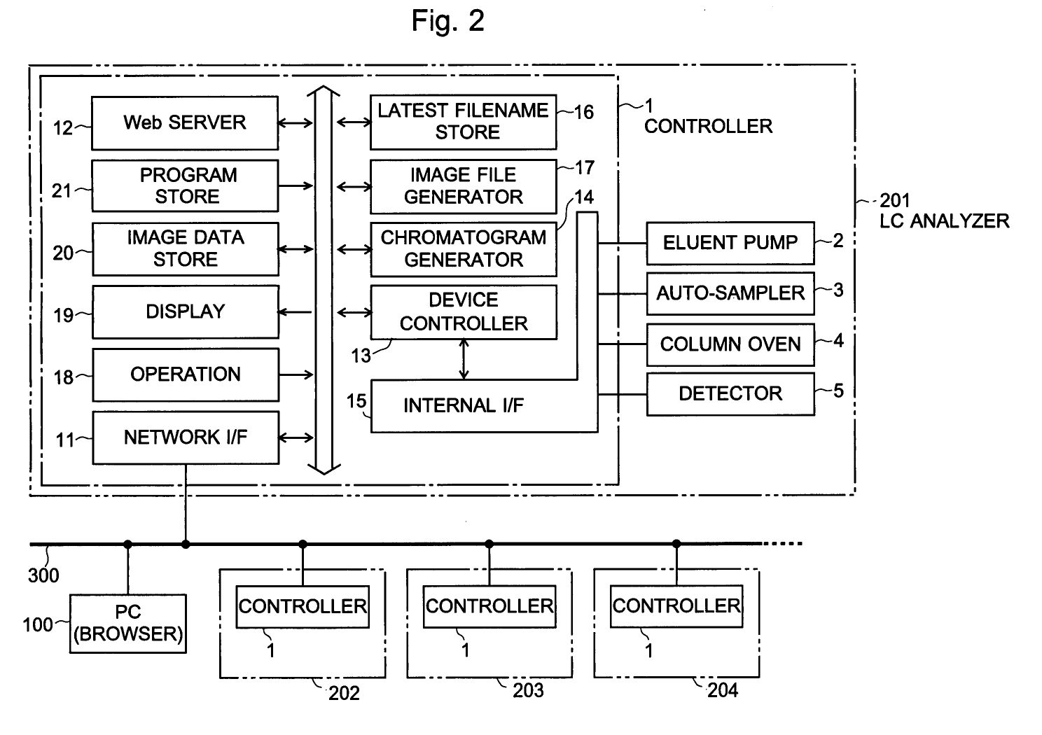

The controller unit 1 of the LC analyzer 201 is shown in detail in FIG. 2. The controller unit 1 includes: a network interface (I/F) 11 which is connected to a network 300; a web server section 12 for producing a web content to be sent out through the network 300, for receiving requests from other devices on the network 300 and for transmitting them to pertinent parts of the analyzer 201; an device controlling section 13 for sending out control signals for controlling the eluent pump 2, the auto-sampler 3, the column oven 4 and the detector 5 via an internal communication interface 15; a chromatogram generating section 14 for generating a chromatogram using the data from the detector 5 and time data from a built-in clock (not shown); an image file generating section 17 for generating data of a still image of a chromatogram generated as such; a latest filename storing section 16 for storing the filename of the latest (or newest) chromatogram image file; an operating section 18 including a keyboard for inputting operation commands to the controller unit 1; a display section 19 for showing characters and images; an image data storing section 20 for storing data of the still images; and a program storing section 21 for storing a program to be sent to and executed in the PC 100.

On the PC 100, which is connected to the controller unit 1 via the network 300, is installed a commonly-used browser (such as Internet Explorer or Netscape Navigator), and the browser receives a program or a set of web content from the web server section 12 of the controller unit 1, where the web content includes data of still images. The browser then executes the program and analyze the data of the web content to show an image including characters and graphics on the display screen of the PC 100. The web content includes, for example, html documents, still images, scripts, plug-in data, JavaScript, etc.

In the analyzing system described above, it is possible to set and operate continuous analyses of plural samples, auxiliary analysis, or an additional analysis, on each of the four LC analyzers 201-204. That is, when the operator makes a schedule of analysis conditions and order for each of the LC analyzers 201-204 on the PC 100, the schedule itself, or a set of command data corresponding to the schedule, is sent to the controller units 1 of the LC analyzers 201-204 via the network 300. Receiving the schedule, the device controlling section 13 of the controller unit 1 takes a preset amount of samples from the auto-sampler 3, and conducts analyses on them one by one according to the schedule.

In particular, under the control of the controller unit 1, eluent is sucked from the eluent tank, and is supplied to the column at a constant flow rate by the eluent pump 2. The auto-sampler 3 takes a preset amount of sample among those set on a sample rack according to the schedule, and injects the sample at a preset timing into the flowing eluent. The sample is carried by the eluent to the column, which is under a temperature control by the column oven 4 according to the schedule. While the sample flows through the column, the components of the sample are separated, and flow out of the column at different time. The detector 5 detects the components flowing out of the column, and the detection signals are sent from the detector 5 to the controller unit 1 via the A/D converter. The chromatogram generating section 14 of the controller unit 1 builds a chromatogram from the digitized detection data and the time data from the built-in timer.

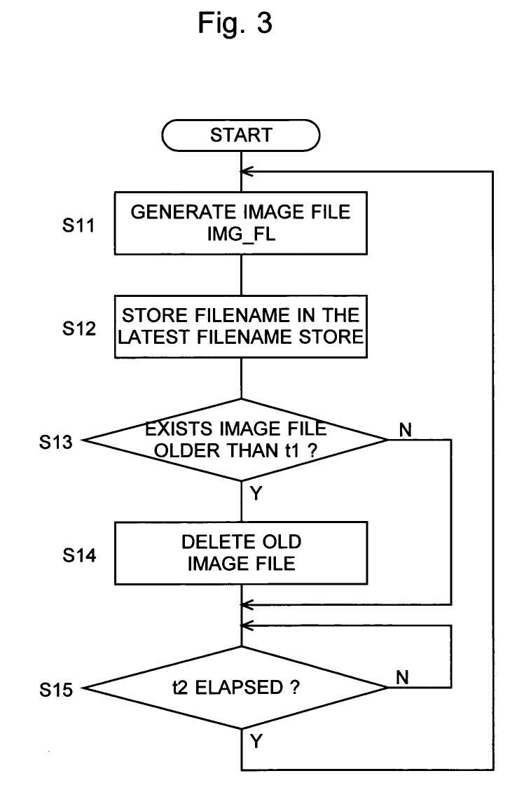

In the meantime, the image file generating section 17 of the controller 1 performs the process steps as shown in FIG. 3. First, it converts the chromatogram produced by the chromatogram generating section 14 into image data, and stores the image data into the image data storing section 20 with an appropriate filename such as IMG_FL001.jpg (S11). It stores the filename, IMG_FL001.jpg, into the latest filename storing section 16 (S12). Then it searches the image data storing section 20 to see whether there is any still-image data file older than a predetermined time period t1 (i.e., stored before the time point of t1 ago)(S13). If such an old still-image data file exists in the image data storing section 20, it deletes the old still-image data file to save the memory space for new still-image data (S14). If such an old still-image data file does not exist, or after such an old still-image data file is deleted, it determines whether a predetermined time interval t2 (three seconds, for example) lapses (S15). The time interval t2 corresponds to the above-described first predetermined time period t1. It waits there until the time interval t2 lapses. When the time interval t2 lapses after the latest image file was created, the process of the image file generating section 17 returns to step S11, where the chromatogram of that time is converted to image data, and stored into the image data storing section 20 with an appropriate filename, e.g., IMG_FL002.jpg (S11). And the filename of the latest image file, IMG_FL002.jpg, is stored in the latest filename storing section 16 (S12). Thus the image file generating section 17 keeps the still image of the latest (newest) chromatogram present in the image data storing section 20. In the generated still image, besides a chromatogram, the data or graph of the pressure of the eluent pump or the column temperature can be included.

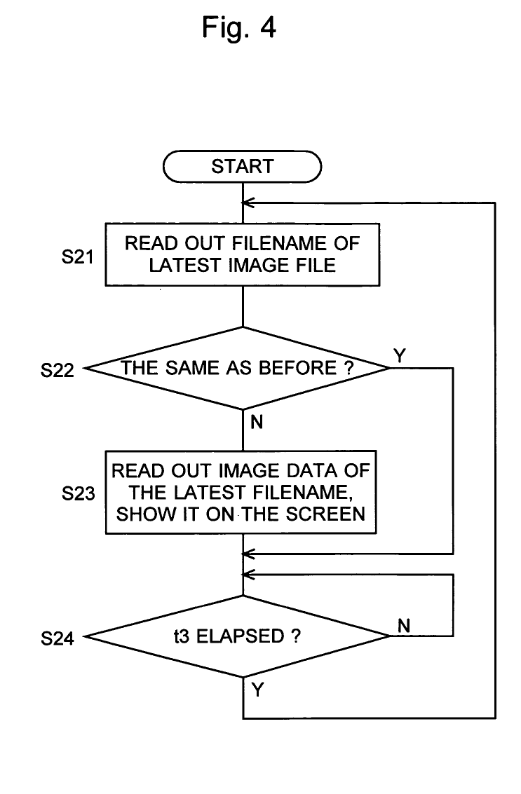

In the PC 100, the browser performs the following process steps. When the user inputs a predetermined URL, usually with a mouse click operation on an appropriate icon, the browser searches the server of the URL on the network. When it finds the server, it establishes a connection with the server, when the PC 100 becomes a client of the server. The PC 100 then accesses the URL of the server. When the web server section 12 of the LC analyzer 201 experiences an access from the client (PC 100), it sends a predetermined program stored in the program storing section 21 to the client. On receiving the program, the browser of the PC 100 executes the program. The process is detailed with reference to FIG. 4.

First, the browser issues a request to the LC analyzer 201 to send the filename of the latest still-image data file (S21). Responsive to the request, the web server section 12 reads out the filename from the latest filename storing section 16, and sends it to the client, or the PC 100. On receiving the filename, the browser examines whether the filename is the same as that received last time (S22). If they are different, the browser sends the filename received this time to the web server section 12 of the LC analyzer 201, and demands the content data of the file. The web server section 12, responsive to the demand, reads out data corresponding to the filename from the image data storing section 20, and sends them to the client, PC 100. Receiving the data, the browser of the PC 100 shows the image of the data on the display screen (S23). If the filenames are the same at step S22, the process proceeds directly to step S24.

At step S24, it is determined whether the second predetermined time interval t3 (five seconds, for example) has lapsed. After waiting the time interval t3, the process returns to step S21, where the browser again sends a request to the LC analyzer 201 for sending the latest filename of the still-image data file.

Thus, on the display screen of the PC 100 that the user uses, the newest image of the chromatogram or other necessary analysis information is always shown.

Although only some exemplary embodiments of the present invention have been described in detail above, those skilled in the art will readily appreciate that many modifications are possible without materially departing from the present invention. Accordingly, all such modifications are intended to be included within the scope of the present invention.

What is claimed is:

1. An analyzer having a function of a server that is connected to a personal computer on which a browser is installed via a network, the analyzer comprising:
a) a still image generating section for generating data of a still image at every first predetermined time interval, and storing the data in a data storing section;
b) a program storing section for storing a program which reads out data of a latest still image from the analyzer at every second predetermined time interval; and
c) a program sending section for sending the program to the personal computer when a predetermined URL of the analyzer is accessed by the browser of the personal computer.

2. The analyzer according to claim 1, wherein:
the still image generating section stores data of still images in the data storing section with different filenames, and stores a filename of data of a latest still image in a latest filename storing section; and
the program first reads out the filename from the latest filename storing section, and then reads out the data of the latest still image from the data storing section based on the filename.

3. The analyzer according to claim 1, wherein the still image generating section deletes data of a still image older than a predetermined time period in order to save the data storing space for data of a newer still image.

4. The analyzer according to claim 2, wherein the still image generating section deletes data of a still image older than a predetermined time period in order to save the data storing space for data of a newer still image.

5. The analyzer according to claim 1, wherein the still image generating section overwrites data of a newer still image onto data of an older still image.

6. The analyzer according to claim 2, wherein the still image generating section overwrites data of a newer still image onto data of an older still image.

7. A method of operating an analyzer having a function of a server that is connected to a personal computer on which a browser is installed via a network, the method comprising steps of:
a) generating data of a still image at every first predetermined time interval, and storing the data in a data storing section of the analyzer;
b) storing a program in a program storing section of the analyzer, where the program is for reading out data of a latest still image from the analyzer at every second predetermined time interval; and
c) sending the program to the personal computer when a predetermined URL of the analyzer is accessed by the browser of the personal computer.

8. The analyzer operating method according to claim 7, wherein:
the data of still images in the data storing section are stored with different filenames, and a filename of data of a latest still image is stored in a latest filename storing section of the analyzer; and
the program first reads out the filename from the latest filename storing section, and then reads out the data of the latest still image from the data storing section based on the filename.

9. The analyzer operating method according to claim 7, wherein the data of a still image older than a predetermined time period is deleted in order to save the data storing space for data of a newer still image.

10. The analyzer operating method according to claim 8, wherein the data of a still image older than a predetermined time period is deleted in order to save the data storing space for data of a newer still image.

11. The analyzer operating method according to claim 7, wherein the data of a newer still image is overwritten onto data of an older still image.

12. The analyzer operating method according to claim 8, wherein the data of a newer still image is overwritten onto data of an older still image.
